(19) United States
(12) Patent Application Publication
(10) Pub. No.: US 2017/0371931 A1
(43) Pub. Date: Dec. 28, 2017

(54) SEARCH ENGINE

(71) Applicant: ecrebo Limited, Marlow-Buckinghamshire (GB)

(72) Inventors: Hassan Hajji, Marlow-Buckinghamshire (GB); Roman Valiusenko, Marlow-Buckinghamshire (GB); Hideki Tai, Marlow-Buckinghamshire (GB)

(73) Assignee: ecrebo Limited, Marlow-Buckinghamshire (GB)

(21) Appl. No.: 15/543,818

(22) PCT Filed: Jan. 14, 2016
(86) PCT No.: PCT/GB2016/050087

§ 371 Date: Jul. 14, 2017

(30) Foreign Application Priority Data
Jan. 14, 2015 (GB) 1500574.7

(51) Int. Cl. G06F 17/30; G06Q 20/04; G06Q 20/20; G06Q 20/38; G06F 17/27

(52) U.S. Cl. CPC G06F 17/30477; G06Q 20/0453; G06F 17/276; G06Q 20/385; G06Q 20/20

(57) ABSTRACT

A computer implemented search method, to be implemented on a computing device, for identifying a user from a first data store, the first data store comprising a plurality of data records, each data record comprising an identifier proxy category for an identifier proxy data item and an associated user identifier category for a user identifier data item, the method comprising: receiving a set of data items relating to a user interaction, the set of data items comprising an identifier proxy data item; formulating an identifier search query comprising the received identifier proxy data item and sending the identifier search query to the first data store containing the plurality of data records; receiving search results from the first data store in the form of one or more data records in which the identifier proxy data item within each returned search result matches the identifier proxy data item in the search query; outputting a user identifier data item from the returned search results.

### FIELD OF THE INVENTION

The present invention relates to a search engine. In particular the present invention relates to a method of searching for user related identification data. The invention extends to a method of searching, a search system and a method of autocompleting a field in a user interface.

### BACKGROUND TO THE INVENTION

The background to the invention is described in relation to a workflow for issuing digital receipts. It is however to be appreciated that the present invention may be applied to other search environments.

Retailers today often offer to send a digital copy of a receipt to an e-mail address or allow the digital receipt relating to a transaction to be accessed by a user via an online service. Digital receipts for a customer (user) are convenient as they may be retrieved and organised electronically easily and quickly. Paper receipts by contrast are difficult to organise and can be easily misplaced, or, if not stored properly, damaged and become useless. For the retailer issuing digital receipts may be beneficial because it can save printer paper and allow (with the customer's agreement) more targeted marketing.

One of the simplest methods allowing digital receipts to be issued is to require a customer to input an e-mail address at a point of sale (POS) system or to spell their e-mail address(es) to a cashier. However, these data entry methods are time consuming and error-prone and an improved user experience may comprise a system that provides email suggestions via an autocomplete function.

Methods to simplify the entering of email addresses may be viewed as a subset of the more general field of autocomplete suggestions which is used in search engines, computer applications, mobile application and the like (for example U.S. Pat. No. 8,645,825 or US2007/0198474).

A simple approach for email clients and services to provide an autocomplete function is to search through a table of email addresses (address book) as the user types in the email address in some text field and to output suggestions as a list of emails that contain the characters entered so far as substrings of the suggested email addresses.

Another approach may be to process email addresses in a more sophisticated way by taking into account how frequently an email address is used and in which contexts (email history, for example) or to use other parameters while determining the relevance of the email while assisting the user as they enter their own address (see U.S. Pat. No. 8,307,038). This method maintains an email address book and entries may be added/removed from the address book.

A further system that may assist with e-mail addresses is described in U.S. Pat. No. 8,495,151 in which a seeking unit may determine missing information in an email address from various sources on the Internet, using a set of rules.

It is an object of the present invention to provide an address completion system and method that overcomes or substantially mitigates problems with known systems/methods.

### STATEMENTS OF INVENTION

According to a first aspect of the present invention there is provided a computer implemented search method, to be implemented on a computing device, for identifying a user from a first data store, the first data store comprising a plurality of data records, each data record comprising an identifier proxy category for an identifier proxy data item and an associated user identifier category for a user identifier data item, the method comprising: receiving a set of data items relating to a user interaction, the set of data items comprising an identifier proxy data item; formulating an identifier search query comprising the received identifier proxy data item and sending the identifier search query to the first data store containing the plurality of data records; receiving search results from the first data store in the form of one or more data records in which the identifier proxy data item within each returned search result matches the identifier proxy data item in the search query; outputting a user identifier data item from the returned search results.

The present invention provides a method of searching for a user and outputting “user identifier data”. The search method according to the first aspect of the present invention comprises a computer implemented method carried out on a computing device, such as a server (see, for example, the digital receipt server described herein). User identifier data (user identifier data items) is (are) stored in a first data store and associated with identifier proxy data items. The search method enables the user identifier data (e.g. an email address) to be retrieved based on the collection of identifier proxy data items (such as payment card details) during a user interaction (e.g. a transaction at a point of sale system). A server (or other computing device) embodying the present invention may therefore retrieve user identification data on the basis of data that is already being captured during the user transaction. Such a search method may reduce the search space that needs to be searched, may increase the speed of searching and may reduce data entry errors (compared to an arrangement where the user is requested to manually enter the user identifier data items).

Search results that are returned from the searchable first data store may be analysed and user identifier data may be output. The output user identifier data may conveniently be returned to a user interaction system (for example a point of sale (POS) system) such that it can be used as part of the user interaction (for example an email address may be returned to a POS system and used by the POS system to send a digital receipt to the user). The user identifier data item may comprise a message routing address for the user, for example an email address.

Optionally, the method comprises outputting the user identifier data item for each returned search result.

Conveniently, the set of data items may be received from a second data store. The set of data items may be received from the searchable second data store in response to a transaction search query being sent to the second data store. The transaction search query may be sent from the computing device. Optionally, the transaction search query may comprise a transaction identifier and conveniently the transaction identifier may be received from a client device. In one embodiment, the transaction identifier may comprise an identifier relating to a transaction at a point of sale system (the client device). The second data store may comprise a payment transaction database that is supplied with transaction related data (transaction data, associated meta-data and the transaction identifier) from the point of sale system. The transaction identifier may in turn be received at the computing device from a client device, e.g. a point of sale system, and the transaction identifier then used to query the second data store in a transaction search query in order to retrieve and receive the set of data items at the computing device.

Optionally, the method comprises outputting the user identifier data item for each returned search result to a client device. Conveniently, the method comprises outputting a list of user identifier data items to the client device. Optionally, the method comprises receiving a request from the client device to send a communication to the user, the communication being directed to a user identifier data item identified in response to the identifier search query and comprising at least some of the set of data items relating to the user interaction. The user identifier data item may comprise a message routing address and the method may comprise sending a communication to this address.

In the event that the search results comprise multiple candidate user identifier data items, the method may comprise receiving partial data relating to the user identifier data item from a client device and using the partial data to filter the candidate user identifier data items to form a filtered set of user identifier data items. In an embodiment where the user identifier data item comprises an email address, the method may therefore comprise receiving some characters relating to the email address (partial data) from the user via the client device and using these characters to filter the candidate email addresses.

The method may comprise outputting the filtered set when the number of candidate user identifier data items in the filtered set meets a predetermined threshold. The predetermined threshold may be set such that it equals a single user identifier data item. In the above embodiment the computing device may only output the user identifier data item when there is only one match (e.g. one email address). Conveniently, outputting a filtered list only helps to safeguard data from other users who are not part of the user interaction.

Optionally, the method comprises storing the set of data items as a new data record within the first data store. Optionally, the method comprises adding a user identifier data item to the new data record once the user identifier data item has been confirmed by the user.

The received set of data items may comprise a plurality of identifier proxy data items. Optionally, the method may comprise formulating the identifier search query using a subset of the plurality of identifier proxy data items. Optionally, the method may comprise formulating the identifier search query using the plurality of identifier proxy data items. Conveniently, the method may comprise analysing the plurality of data items to determine the identifier proxy data category most frequently associated with a user identifier data item.

The user interaction may comprise a transaction at a point of sale system. The first data store may comprise historic transaction data which may be stored in the form of a database. The second data store may comprise transaction data relating to a current transaction. The user identifier data item may comprise an email address for the user. The identifier proxy data item may comprise one or more selected from: a primary account number of a transaction card belonging to the user; a masked primary account number of a transaction card belonging to the user; a loyalty card number of a loyalty card belonging to the user. The computing device may comprise a server.

According to a second aspect of the present invention there is provided a search engine module for identifying a user from a first data store, the first data store comprising a plurality of data records, each data record comprising an identifier proxy category for an identifier proxy data item and an associated user identifier category for a user identifier data item, the module comprising: an input arranged to receive a set of data items relating to a user interaction, the set of data items comprising an identifier proxy data item; a processor arranged to formulate an identifier search query comprising the received identifier proxy data item and send the identifier search query to the first data store containing the plurality of data records, the input being further arranged to receive search results from the first data store in the form of one or more data records in which the identifier proxy data item within each returned search result matches the identifier proxy data item in the search query; and an output arranged to output a user identifier data item from the returned search results.

According to a third aspect of the present invention there is provided a server comprising a search engine module according to the second aspect of the present invention.

According to a fourth aspect of the present invention there is provided a computer implemented search method for identifying a user from a first data store, the first data store comprising a plurality of data records, each data record comprising an identifier proxy category for an identifier proxy data item and an associated user identifier category for a user identifier data item, the method comprising: sending, from a client device, a user identifier search request to a computing device; performing, on the computing device, the method according to the first aspect of the invention; receiving a list of candidate user identifier data items from the computing device; receiving partial data relating to the user identifier data item from a user; filtering the list of candidate user identifier data items on the basis of the partial data to form a filtered list; outputting the filtered list to an output device.

The output device may comprise a display device and an associated input device, e.g. a display screen plus a keypad device. The output device may also comprise a touchscreen.

According to a fifth aspect of the present invention there is provided a search system for identifying a user comprising: a client device; a computing device comprising a search engine module according to the second aspect of the present invention; a first data store comprising a plurality of data records, each data record comprising an identifier proxy category for an identifier proxy data item and an associated user identifier category for a user identifier data item.

The computing device may be arranged to receive a request from the client device to provide user identifier data items and to search the first data store according to the method of the first aspect of the present invention.

According to a sixth aspect of the present invention there is provided a method of autocompleting a field in a user interface, the method comprising: sending a user identifier search request to a computing device; receiving a list of candidate user identifier data items from the computing device, the computing device being arranged to perform the method according to the first aspect of the present invention; receiving partial data relating to the candidate user identifier data items from a user; filtering the list of candidate user identifier data items on the basis of the partial data to form a filtered list; outputting the filtered list to the user interface in order to autocomplete the field in the user interface.

The computing device may be arranged to perform the method according to the first aspect of the present invention.

The invention extends to a non-transitory computer readable storage medium comprising computer readable instructions for a computer processor to carry out the method of the first aspect of the present invention.

The second, third, fourth, fifth and sixth aspects of the present invention may comprise preferred features of the first aspect of the present invention.

Embodiments of the invention may include domain name auto-completion as well as the actual recipient part auto-completion. For this to work, the application should maintain a table of e-mail addresses, and search in this table as the user is typing in first characters of the e-mail address. Once a unique match is found (or some threshold of maximum number of e-mail suggestions is reached), it may be presented on the screen for auto-completion.

An advantage of the present invention is that it makes e-mail entering quicker and easier for the customer.

Further advantages associated with embodiments of the present invention are noted below (in the context of an embodiment where an email address for a customer (user) taking part in a transaction is being request):
Data from a transaction receipt may be used to narrow down the search space. Transaction receipt data that may be used any of one of the following (but is not limited to the list given below) or any combination of these:
   Geographical store location/address.
   A Masked PAN (primary account number of a payment card) and/or other payment card information such as card name and/or expiry date.
   A Loyalty card number or its masked PAN.
   Time and date of the transaction
   Frequency of the e-mail address usage.
   The domain name of the email address that is being searched for may be requested before searching for the email address name in order to narrow the search space.
The address book (comprising candidate e-mail addresses) may be stored on a remote machine and/or be cached locally at a point of sale (POS) system, either in full or partially.
Such a searching method and system according to embodiments of the present invention do not require the modification of existing POS software and hardware. Instead an interception module as described in WO2013008041 may be installed as a virtual driver within the POS system in order to intercept transaction related data as it is sent between various components of the POS system (e.g. between the POS terminal and a printer; between POS terminal and a scanner; between POS terminal and a payment terminal etc.).
The system according to present embodiments of the invention minimises the disclosure of e-mail addresses to other users while giving suggestions.
The system may employ fuzzy string search algorithms to give correct suggestions even if a user mistypes and e-mail address improving on user-experience.
The system may analyze the frequency of e-mail address usage and searches in among the most frequently e-mail addresses first, or may employ other statistical of heuristic algorithms.

Further embodiments of the present invention are described in the numbered clauses below.

1. A method to enable users to input her/his address with a few key types may comprise:
a step to extract identifier proxies included in transaction data and/or transaction meta-data or any other information available at POS terminal,
a step to store associations of identifier proxy to e-mail address, and
a step to query the said associations to get a list of candidate e-mail addresses and domain names,
a step to confine the said candidate addresses each time a character is typed; and
a step to complete a destination address once the said candidate address could be confined to one or some threshold of maximum number of e-mail suggestions
   2. A method of clause 1, wherein the said transaction data may be the data available on the printed receipt and the transaction meta-data may be all the other data that can be obtained from the scanner, payment terminal, pole display, keyboard, magnetic stripe reader, PDQ/payment terminals, or generally any other hardware attached to the till, as well via API that are available at the till.
   3. A method of clause 1, wherein the said step to store associations of identifier proxies to e-mail addresses may take into account the transaction data and/or transaction meta-data.
   4. A method of clause 3, wherein the said transaction data and/or transaction meta-data may include geographical location of the till/store.
   5. A system to enable users to input her/his address with a few key types comprises:
a database in which associations from the said identifier proxies to the said e-mail address may be stored; and
a client software component which may ask an e-mail address to where a digital receipt should be delivered comprising:
   a function to query a list of destination addresses which may match any identifier proxies available in the transaction data and/or meta-data (e.g. masked PAN of payment card number, or loyalty card number, and/or branch location), and
   a function to complete destination address after one or more characters are typed; and
      6. The system of clause 1, wherein the said function to query a list of destination addresses may be done by a server comprising:
function to analyze transaction data and/or meta-data to extract identifier proxies and to store associations between the said extracted identifier proxies and destination address into the said database; and
function to query the said database with the extracted identifier proxies and/or transaction data (and/or its parts) or transaction meta-data (and/or its parts).

### BRIEF DESCRIPTION OF THE DRAWINGS

One or more embodiments of the invention will now be described, by way of example only, with reference to the accompanying drawings, in which:

FIG. 1 shows a system in accordance with embodiments of the present invention;

FIG. 2 shows a user interface in accordance with embodiments of the present invention;

FIG. 3 shows data records in accordance with embodiments of the present invention;

FIG. 4 shows a flow chart of a mode of operation of the system of FIG. 1.

### DETAILED DESCRIPTION

Embodiments of the present invention are described herein in the context of the issuance of a digital receipt in a digital receipts system though the person skilled in the art will appreciate that the methods and systems described herein may be applied to a range of search and autocomplete tasks.

In the following description the following terminology is used:

“PAN” is an acronym for “primary account number”, e.g, the “card number” on a debit or a credit card.

A “Masked PAN” (masked primary account number) is a partly or totally obscured PAN. In many cases, the last 4-digits of the full PAN are used as a masked PAN. Masking a PAN hides the full card number from anyone who obtains a transaction receipt while allowing a card holder who has multiple debit/credit cards to identify which card was used in a given transaction.

An “Identifier Proxy data item” as used herein is a data item that may be associated with a user identifier. A masked PAN is an example of an identifier proxy data item.

Embodiments of the present invention may use identifier proxy data items that may not be unique to a particular user (e.g. the masked PAN of a first user's card may be the same as the masked PAN of a second user's card even though the full PANs are different). Embodiments of the present invention however store identifier proxy data items and user identifier data items (e.g. email addresses) in data records that allow a search engine in accordance with embodiments of the present invention to search and locate user identifier data items more accurately and quickly than prior systems.

Embodiments of the present invention provide systems and methods to complete the e-mail address of a user who requires a digital receipt relating to a transaction. A requirement particular to this activity is to avoid exposing email addresses of other users within the system unnecessarily. Email entry may occur in a public environment via an input device that may be used by many different users (customers) and which may be observed by different users. Autocomplete suggestions relating to email addresses should therefore preferably only be output when the candidate addresses are limited to a predefined accuracy limit.

To satisfy the above accuracy requirement, embodiments of the present invention utilise identifier proxy data items available from information collected during a transaction at a POS system such as loyalty card number and a combination of masked PAN of payment card, expiration date, and card type.

It is noted that a particular identifier proxy data item may not have a unique relationship with a particular user identifier. For example, a masked PAN may comprise the last 4 digitals of a full PAN. If a masked PAN is used as an identifier proxy data item therefore it may be the case that different users have the same last 4 card digits even though the full card numbers are different. It is also noted that a particular user identity data item (e.g. an email address) may be associated with different identifier proxy data items. For example, a user's email address could be associated with multiple transaction cards belonging to that user.

In an embodiment of the invention, a searching method comprises extracting identifier proxy data items from data generated during a transaction or any other available information, recording associations from the extracted identifier proxy data items to an email address each time a digital receipt is sent out, querying the recorded associations using a search method according to embodiments of the present invention when a user subsequently requests a digital receipt to be issued, and automatically completing their email address when the number of query results is limited to one or some threshold of maximum number of email suggestions.

It is noted that when a user (customer) requests the sending of a digital receipt for the first time, embodiments of the present method may complete the domain name part of the email address by referring to a list of domain names that frequently appear in the dispatch history of the digital receipts issuing system and/or any other available information. Once a user has received a digital receipt before, embodiments of the present invention may complete the user's email address by referring to identifier proxy data items found in the transaction data from the POS system and the dispatch history. Email address may only be completed when the number of candidate addresses is limited to one or some threshold of maximum number of email suggestions. With this method, specifying email address during a transaction at a POS system may be done efficiently, for example with just a couple of key entries at a user interface device especially where the user has requested digital receipts a number of times in the past such that there are a number of data records within the dispatch history of the system.

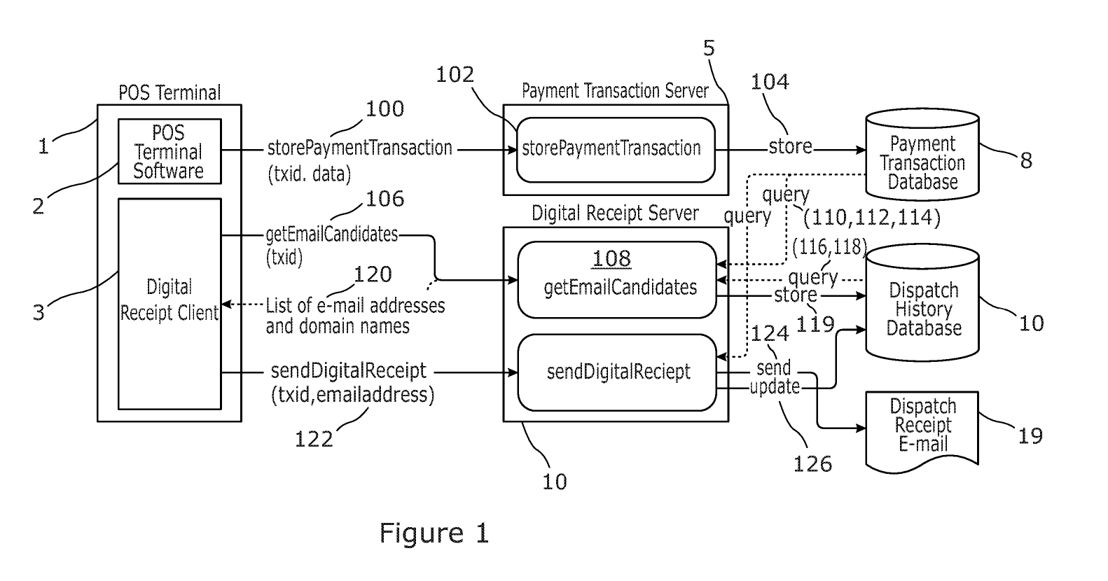

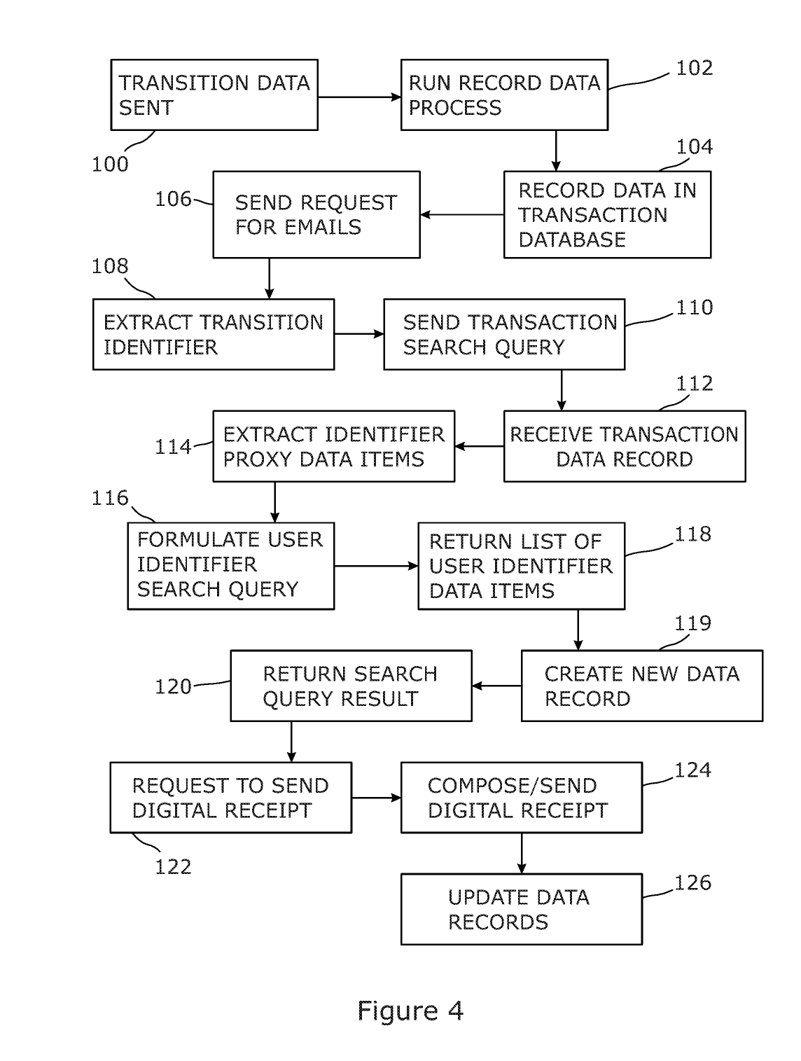

FIG. 1 describes an overview of a search system and process in accordance with embodiments of the present invention. The search process is also shown in FIG. 4.

In FIG. 1, a point of sale (POS) terminal 1 within a POS system runs POS terminal software 2 and a digital receipt client 3. The digital receipt client is arranged to provide a user interface for both the POS operator (cashier) and a user (consumer) during a transaction.

The POS terminal is in communication with a payment transaction server 5 and a digital receipt server 10. The payment transaction server 5 is in communication with a data store 8, the payment transaction database. The digital receipt server 10 is in communication with a further data store 14, the dispatch history database. The data store 14 corresponds to the first data store of the claims and the data store 8 corresponds to the second data store of the claims.

It is noted that in FIG. 1 the POS terminal 1, payment transaction server 5, digital receipt server 10, and databases 8 and 14 are shown to be separate components. In alternative arrangements some or all of these components could be located together. For example, the digital receipt server 10 and database 14 could be located local to the POS system or even as part of the POS system.

A mode of operation of the arrangement shown in FIG. 1 is now described.

At a point during a transaction, the user enters payment information in order to pay for the items they are purchasing. Then in step 100, the POS terminal software (2) sends a communication to the payment transaction server (5), the communication comprising transaction related data (e.g. transaction data such as payment card information (which corresponds to an identifier proxy data item) and items purchased and associated meta data such as a transaction identifier).

In step 102, in response to the communication received from step 100, a process in the payment transaction server (5) is run in order to record the transaction related information into the payment transaction data base (8).

In step 104 therefore, the transaction related data is sent to and stored in the database 8 as a transaction data record. The stored transaction record comprises one or more identifier proxy categories for storing the received identifier proxy data items within the transaction related data. Examples of identifier proxy data items include, but are not limited to, a PAN category, a masked PAN category, a loyalty card number category).

In the transaction environment shown in FIG. 1, once the payment process is complete, the digital receipt client (3) is arranged to output a message asking whether a digital receipt needs to be sent or not.

If a digital receipt is required then an email address for the user (or other suitable user identifier data item such as a mobile telephone number) will be needed in order to deliver the receipt. Consequently, in step 106, the digital receipt client (9) sends a request to the digital receipt server (10) to provide candidate email addresses for the user. The request comprises a transaction ID (txid). (It is noted that communication in step 100 comprises the transaction ID).

Receipt of the request from step 106 by the server 10 starts a transaction search method in accordance with an embodiment of the present invention. In step 108 a process is run in the digital receipt server (10) which extracts the transaction ID (txid) from the received request.

In step 110, the server 10 formulates and sends a transaction search query to the payment transaction database 8, the transaction search query comprising the transaction ID.

In step 112, the server 10 receives the transaction data record (this corresponds to the “set of data items” in the claims) corresponding to the provided transaction ID and is arranged in step 114 to extract identifier proxy data items corresponding to the identifier proxy categories within the received transaction data.

In step 116 a (or the) extracted identifier proxy data item(s) is used to formulate an identifier search query which is sent to the dispatch history database 14 which contains details of historic transaction related data.

The database 14 returns, in step 118, a list of user identifier data items (email address candidates in the present example embodiment) and a list of domain names.

In step 119, the server 10 creates a new data record entry in the database 14 and stores the extracted identifier proxy data items/received transaction data record into the database.

In step 120, the server 10 returns the search query result (the list of candidate user identifier data items and domain names) back to the digital receipt client 3.

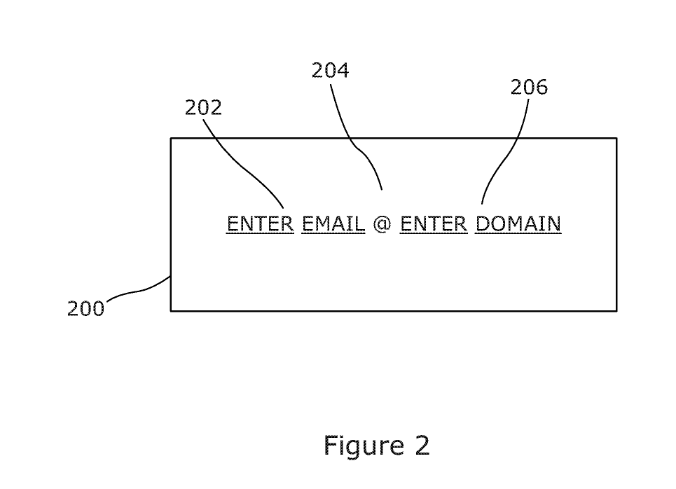

The digital receipt client will then present a dialog user interface 200, shown in FIG. 2, to the user to ask for their email address. The client 3 is arranged to filter the candidate user identifier data items each time a character is typed in to an address part 202 of an input field 204 of the user interface. When the number of candidate user identifier data items falls below a predefined threshold of maximum number of suggestions, the input field of the user interface may be completed.

In a preferred embodiment the complete user interface data item is presented to the user only when there is a single matching candidate. Depending on the identifier proxy data items stored in the database 14 and available to the server 10, the user identifier search may only return a single candidate email address, in which case the user may be presented with this address and simply asked to confirm this is the correct address to send the digital receipt to.

As an alternative, a user may enter characters in the user interface in the domain name part 206 of the input field. In such an alternative, the receipt client 3 is arranged to filters the list of domain names and complete the user interface with the most preferable one.

Once the e-mail address has been determined, the client 3 sends, in step 122, a request to the digital receipt server 10 to send a digital receipt to the determined email address.

In Step 124 the digital receipt corresponding to the transaction is composed and sent out to the specified e-mail address. Once it is confirmed that the digital receipt was sent out successfully, the server 10 updates (step 126) the data records in the dispatch history database 14 to fill the email address into the data record created in step 119.

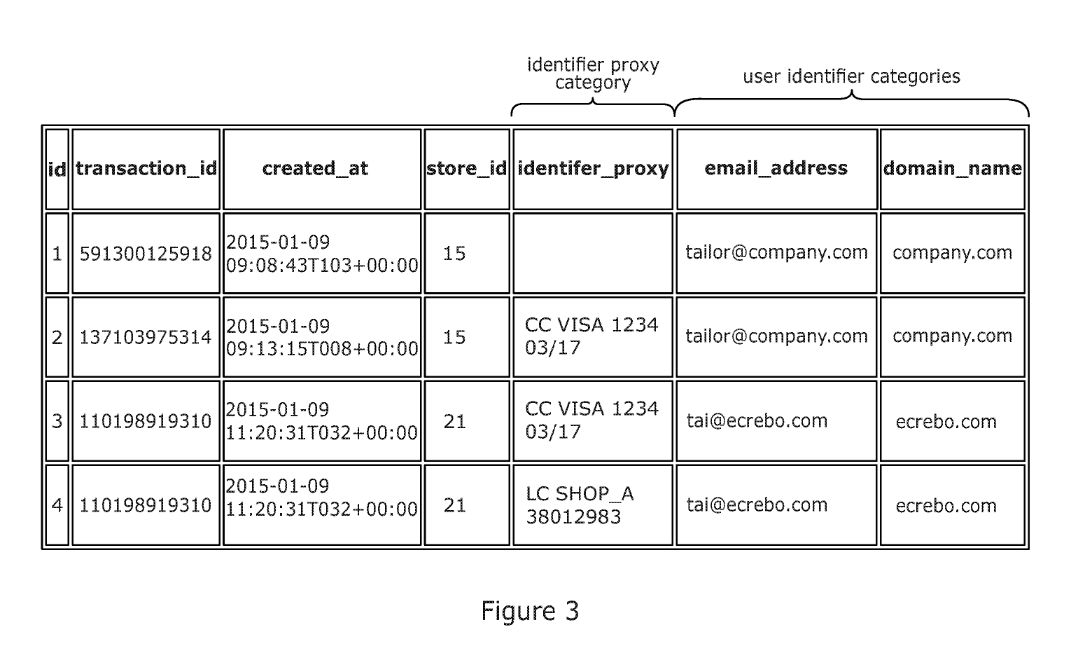

FIG. 3 shows an embodiment of the data records stored within the dispatch history database 14 to store associations between identifier proxy data items and email addresses.

Column “id” is the primary key of this data record table. Column “transaction_id” represents a key to identify a particular payment transaction. Column “created_at” represents the time when the record was created. Column “store_id” represents the store where the payment transaction occurred.

Column “identifier_proxy” represents an identifier proxy category field. Identifier proxy data items that appeared in payment transactions are stored in this field. In the present embodiment, the first two characters represents the type of the identity proxy; “CC” is for credit card while “LC” represents loyalty card. This column may be left empty if no identifier proxy data item was found in the payment transaction (e.g. in a case where the user pays by by cash without presenting another identity information such as a loyalty card). Column “email_address” and “domain_name” represent e-mail addresses and associated domain names to which a digital receipt was sent out successfully. Entries in the “Email address” and “domain name” fields represent user identifier data items and these columns of the table relate to user identifier categories.

As explained above, data records within the table in FIG. 3 are created at step 119 of FIG. 1. During step 119, columns “email_address” and “domain_name” are not completed.

In the table shown in FIG. 3, the first record (id=1) represents that it was paid by cash or no identifier proxy data item was found within the transaction related data seen by the server 10. The second record (id=2) represents that it was paid by a VISA credit card whose last four digits were “1234” and expiration date was “03/17”.

The third record (id=3) represents that it was paid by a VISA credit card whose last four digits were “1234” and expiration date was “03/17.” Note that the transactions corresponding to the second and the third record may not be paid by the same credit card in spite of their identifier proxy data items being identical. The fourth record (id=4) represents that a loyalty card was presented for the payment transaction corresponding to the third record.

In step 116 of FIG. 1, the digital receipt server 10 queries the table of FIG. 3 with a condition that the “identifier_proxy” data item of a data record should match an identifier proxy data item that appeared in the payment transaction data that is going to be sent as a digital receipt.

If the consumer paid by cash and indicated a loyalty card whose identifier proxy is “LC SHOP_A 38012983”, the query will only receive (in step 118) the fourth data record. In this case the candidate user identifier data item will only be “tai@ecrebo.com”.

If the consumer paid by a credit card whose identifier proxy is “CC VISA 1234 03/17”, the query will get the second and the third data records so the candidate user identifier data items will be “tailor@company.com” and “tai@ecrebo.com”. A list of domain names may be obtained by querying “domain_name” column from all records. The user may also be presented with a list of popular domain names as part of the email address confirmation process, the selection of which may reduce the search space that needs to be checked in order to output a list of candidate email addresses.

Assuming that the digital receipt client 3 is configured to autocomplete the user identifier data item field in the user interface only when the number of candidate addresses is limited to one, and email address candidates of “tailor@company.com” and tai@ecrebo.com have been returned by the server 10, then the digital receipt client 3 will complete the e-mail address input field with “tailor@company.com” when “tail” is typed in. Or it will complete with “tai@company.com” when “tai” followed by enter key or “@” was typed in.

The method may also incorporate “store_id” too. If the payment transaction occurred at a store whose id is “21”, the digital receipt client may complete the e-mail address input field with “tai@ecrebo.com” just when “t” was typed (Users may revisit the same set of stores in most transactions they take part it. Such transaction behaviour may allow the search space to be narrowed to a particular store or to prioritise candidate search results. In the present case, in store “21”, tai@ecrebo.com is the only email address that is associated with “CC VISA 1234 03/17”. As such it may be assumed that tai@ecrebo.com is the correct candidate email address when such an identifier proxy data item is received).

In order to reduce the candidate user identifier data item (or in case no candidate entries exist), then the digital receipt client may ask a user to input a domain name at first.

As the person skilled in the art will appreciate, modifications and variations to the above embodiments may be provided, and further embodiments may be developed, without departing from the spirit and scope of the invention. Reference to standards and proprietary technologies are provided for the purpose of describing effective implementations, and do not limit the scope of the invention.

1. A computer implemented search method, to be implemented on a computing device, for identifying a user from a first data store, the first data store comprising a plurality of data records, each data record comprising an identifier proxy category for an identifier proxy data item and an associated user identifier category for a user identifier data item, the method comprising:
receiving a set of data items relating to a user interaction, the set of data items comprising an identifier proxy data item
formulating an identifier search query comprising the received identifier proxy data item and sending the identifier search query to the first data store containing the plurality of data records
receiving search results from the first data store in the form of one or more data records in which the identifier proxy data item within each returned search result matches the identifier proxy data item in the search query;
outputting a user identifier data item from the returned search results.

2. A method as claimed in claim 1, comprising outputting the user identifier data item for each returned search result.

3. A method as claimed in claim 1 or claim 2, wherein the set of data items are received from a second data store.

4. A method as claimed in claim 3, wherein the set of data items are received from the second data store in response to a transaction search query being sent to the second data store.

5. A method as claimed in claim 4, wherein the transaction search query comprises a transaction identifier.

6. A method as claimed in claim 5, wherein the transaction identifier is received from a client device.

7. A method as claimed in any preceding claim, comprising outputting the user identifier data item for each returned search result to a client device.

8. A method as claimed in claim 7, comprising outputting a list of user identifier data items to the client device.

9. A method as claimed in claim 7 or claim 8, comprising receiving a request from the client device to send a communication to the user, the communication being directed to a user identifier data item identified in response to the identifier search query and comprising at least some of the set of data items relating to the user interaction

10. A method as claimed in any preceding claim, wherein in the event the search results comprise multiple candidate user identifier data items, the method comprises receiving partial data relating to the user identifier data item from a client device and using the partial data to filter the candidate user identifier data items to form a filtered set of user identifier data items.

11. A method as claimed in claim 10, the method comprising outputting the filtered set when the number of candidate user identifier data items in the filtered set meets a predetermined threshold.

12. A method as claimed in claim 11, wherein the predetermined threshold equals a single user identifier data item.

13. A method as claimed in any preceding claim, comprising storing the set of data items as a new data record within the first data store.

14. A method as claimed in claim 13, comprising adding a user identifier data item to the new data record once the user identifier data item has been confirmed by the user.

15. A method as claimed in any preceding claim, wherein the received set of data items comprises a plurality of identifier proxy data items.

16. A method as claimed in claim 15, comprising formulating the identifier search query using a subset of the plurality of identifier proxy data items.

17. A method as claimed in claim 15, comprising formulating the identifier search query using the plurality of identifier proxy data items.

18. A method as claimed in any preceding claim, comprising analysing the plurality of data items to determine the identifier proxy data category most frequently associated with a user identifier data item.

19. A method as claimed in any preceding claim, wherein the user interaction comprises a transaction at a point of sale system.

20. A method as claimed in any preceding claim, wherein the first data store comprises historic transaction data.

21. A method as claimed in any preceding claim, wherein the second data store comprises transaction data relating to a current transaction.

22. A method as claimed in any preceding claim, wherein the user identifier data item comprises an email address for the user.

23. A method as claimed in any preceding claim, wherein the identifier proxy data item comprises one or more selected from: a primary account number of a transaction card belonging to the user; a masked primary account number of a transaction card belonging to the user; a loyalty card number of a loyalty card belonging to the user.

24. A method as claimed in any preceding claim, wherein the computing device comprises a server.

25. A search engine module for identifying a user from a first data store, the first data store comprising a plurality of data records, each data record comprising an identifier proxy category for an identifier proxy data item and an associated user identifier category for a user identifier data item, the module comprising:
an input arranged to receive a set of data items relating to a user interaction, the set of data items comprising an identifier proxy data item;
a processor arranged to formulate an identifier search query comprising the received identifier proxy data item and send the identifier search query to the first data store containing the plurality of data records, the input being further arranged to receive search results from the first data store in the form of one or more data records in which the identifier proxy data item within each returned search result matches the identifier proxy data item in the search query;
and an output arranged to output a user identifier data item from the returned search results.

26. A server comprising a search engine module according to claim 25.

27. A computer implemented search method for identifying a user from a first data store, the data store comprising a plurality of data records, each data record comprising an identifier proxy category for an identifier proxy data item and an associated user identifier category for a user identifier data item, the method comprising:
sending, from a client device, a user identifier search request to a computing device;
performing, on the computing device, the method according to any one of claims 1 to 24;
receiving a list of candidate user identifier data items from the computing device;
receiving partial data relating to the user identifier data item from a user;
filtering the list of candidate user identifier data items on the basis of the partial data to form a filtered list;
outputting the filtered list to an output device.

28. A search system for identifying a user comprising:
a client device;
a computing device comprising a search engine module according to claim 25;
a first data store comprising a plurality of data records, each data record comprising an identifier proxy category for an identifier proxy data item and an associated user identifier category for a user identifier data item.

29. A method of autocompleting a field in a user interface, the method comprising:
sending a user identifier search request to a computing device;
receiving a list of candidate user identifier data items from the computing device, the computing device being arranged to perform the method according to any one of claims 1 to 24;
receiving partial data relating to the candidate user identifier data items from a user;
filtering the list of candidate user identifier data items on the basis of the partial data to form a filtered list;
outputting the filtered list to the user interface in order to autocomplete the field in the user interface.

30. A non-transitory computer readable storage medium comprising computer readable instructions for a computer processor to carry out the method of any one of claims 1 to 24.
